(19) United States
(12) Patent Application Publication
(10) Pub. No.: US 2026/0079027 A1
(43) Pub. Date: Mar. 19, 2026

(54) INFORMATION PROCESSING APPARATUS AND STORAGE MEDIUM

(71) Applicant: KABUSHIKI KAISHA TOSHIBA, Minato-ku, Tokyo (JP)

(72) Inventors: Daisuke UCHIDA, Yokohama Kanagawa (JP); Kentaro TANIGUCHI, Kawasaki Kanagawa (JP)

(73) Assignee: KABUSHIKI KAISHA TOSHIBA, Minato-ku, Tokyo (JP)

(21) Appl. No.: 19/285,378

(22) Filed: Jul. 30, 2025

(30) Foreign Application Priority Data
Sep. 17, 2024 (JP) 2024-159839

(51) Int. Cl. G01C 21/00; B25J 9/16; H04B 17/318

(52) U.S. Cl. CPC G01C 21/3859; B25J 9/1679; H04B 17/318

(57) ABSTRACT

According to one embodiment, an information processing apparatus including an acquisition device configured to acquire, from a plurality of wireless devices, a strength of an interference signal different from communication signals of the wireless devices, and an environment update unit configured to update a map indicating an environment in a case where a change in the environment in which the wireless devices move is detected based on a temporal change in the strength of the interference signal.

### CROSS-REFERENCE TO RELATED APPLICATIONS

This application is based upon and claims the benefit of priority from Japanese Patent Application No. 2024-159839, filed Sep. 17, 2024, the entire contents of which are incorporated herein by reference.

### BACKGROUND

Embodiments described herein relate generally to an information processing apparatus and a storage medium.

In recent years, for example, a moving object that autonomously moves in a factory or the like has become known. An example of the moving object is a conveyance robot. The moving object moves on a predetermined route while a position of the moving object on a map is estimated based on the map and sensor information. The map indicates an environment of a space where the moving object moves. The sensor information is obtained from a distance sensor in the moving object. In the following description, examples of the “environment” are positions (dispositions) of walls, pillars, doors, and obstacles.

However, an environment indicated on the map may be different from an environment of the moving object which is actually moving due to a layout change in a factory or the like. In this case, the moving object may not be able to estimate self-position on the map, and the moving object may not operate correctly.

### BRIEF DESCRIPTION OF THE DRAWINGS

FIG. 1 is a diagram illustrating a configuration example of a moving object that autonomously operates according to a comparative example of a first embodiment.

FIG. 2 is a diagram illustrating a basic configuration example of the server according to the first embodiment.

FIG. 3 is a diagram illustrating a position of a moving object and a position of the moving object on a map estimated by a server in a comparative example of the first embodiment.

FIG. 4 is a diagram for describing a principle of SLAM used in the server according to the first embodiment.

FIG. 5 is a diagram illustrating a functional configuration example of the server according to the first embodiment.

FIG. 6 is a diagram illustrating a hardware configuration example of the server according to the first embodiment.

FIG. 7 is a diagram illustrating an example of a target space managed by the server according to the first embodiment.

FIG. 8 is a diagram illustrating temporal change in a range in which environment information can be acquired by a moving object and an image sensor connected to the server according to the first embodiment.

FIG. 9 is a diagram illustrating an example of a target space managed by the server according to the first embodiment.

FIG. 10 is a flowchart illustrating an example of map update processing of the server according to the first embodiment.

FIG. 11 is a diagram illustrating a functional configuration of a server according to a second embodiment.

FIG. 12 is a diagram for describing an interference signal used by the server according to the second embodiment.

FIG. 13 is a diagram for describing an outline of a method of detecting a change in a surrounding environment according to the second embodiment.

FIG. 14 is a diagram for describing an outline of a method of detecting a change in a surrounding environment according to the second embodiment.

FIG. 15 is a flowchart illustrating an example of a flow of map update processing of the server according to the second embodiment.

FIG. 16 is a diagram for describing a received power map used by the server according to the second embodiment.

FIG. 17 is a diagram for describing the received power map used by the server according to the second embodiment.

FIG. 18 is a diagram illustrating a specific example in a case where a server 20 according to the second embodiment is applied.

FIG. 19 is a diagram illustrating a specific example in a case where the server 20 according to the second embodiment is applied, which is subsequent to FIG. 18.

FIG. 20 is a diagram illustrating a specific example in a case where the server 20 according to the second embodiment is applied, which is subsequent to FIG. 19.

FIG. 21 is a diagram illustrating a specific example in a case where the server 20 according to the second embodiment is applied, which is subsequent to FIG. 20.

### DETAILED DESCRIPTION

Hereinafter, embodiments will be described with reference to the drawings.

Note that the disclosure is merely an example, and the invention is not limited by the content described in the following embodiments. Modifications which a person skilled in the art could easily conceive are naturally included in the scope of the disclosure. In order to make the description clearer, a size, a shape, and the like of each part may be schematically represented by being changed from those of the actual embodiment in the drawings. In the plurality of drawings, corresponding elements are denoted by the same reference numerals, and a detailed description thereof may be omitted.

In general, according to one embodiment, an information processing apparatus including an acquisition device configured to acquire distance sensor information, moving distance of a plurality of wireless devices, and received power information from each of the wireless devices, and acquire image information from an image sensor, a map generator configured to generate a map indicating an environment in which the wireless devices move based on the distance sensor information and the moving distance of each of the wireless devices acquired in a predetermined period, and an environment update unit configured to update the map in a case of detecting a change in the environment indicated in the map based on at least one of the distance sensor information, the received power information, and the image information acquired after the predetermined period.

### First Embodiment

A first embodiment will be described.

An information processing apparatus (hereinafter, referred to as a server) according to the present embodiment is used to control a moving object that moves in a predetermined space (hereinafter, referred to as a target space) such as in a factory or a warehouse. Hereinafter, the information processing apparatus is referred to as a server. The predetermined space is referred to as a target space. Examples of the moving object include a conveyance robot, a cleaning robot, a security robot, and a guide robot.

The moving object may be roughly classified into one that operates autonomously and one that operates based on an external command. The external command is referred to as a control signal. The server according to the first embodiment is used to control the latter moving object.

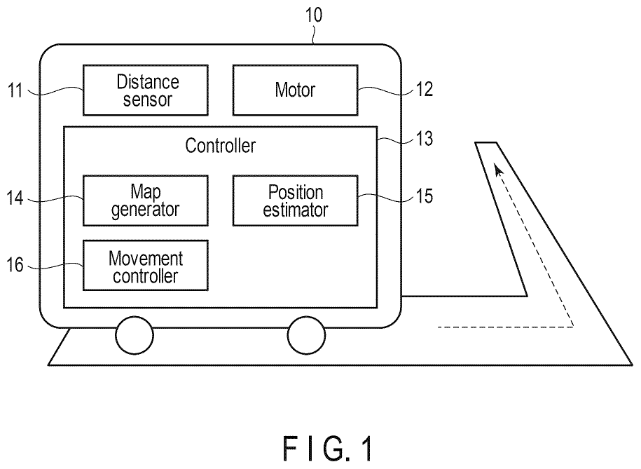

Here, as a comparative example, a moving object that autonomously operates will be described. FIG. 1 illustrates a configuration example of a moving object 10 that autonomously operates.

The moving object 10 includes, for example, a distance sensor 11, a motor 12, and a controller 13.

The distance sensor 11 acquires a distance to an object present around the moving object 10. For example, the object is a wall, a pillar, or an obstacle. The distance sensor 11 is, for example, a laser range finder (LRF) or a LiDAR. The distance sensor 11 measures a time of flight (TOF) from when laser (light) is emitted until the laser is reflected by an object and returns, thereby measuring a distance to the object present around the moving object 10. Hereinafter, the distance to the object present around the moving object 10 acquired by the distance sensor 11 will be referred to as “distance sensor information”.

The motor 12 rotationally drives wheels of the moving object 10 under the control of the controller 13. The controller 13 controls the motor 12 such that the moving object 10 moves to, for example, a predetermined destination.

Here, the controller 13 includes a map generator 14, a position estimator 15, and a movement controller 16. Note that the controller 13 calculates a moving distance (odometry) of the moving object 10 based on a rotation amount of the wheel and a direction (rotation angle) of the wheel.

The map generator 14 generates a map indicating the environment of a target space based on at least one of the distance sensor information and the moving distance of the moving object 10. Such a map is also be referred to as an environment map, and indicates positions of a wall forming the target space, a passage in the target space, an object installed in the target space, and the like.

The position estimator 15 estimates a self-position of the moving object 10 on the map based on the map generated by the map generator 14 and the distance sensor information.

The movement controller 16 determines a direction and a moving distance in which the moving object 10 should move based on the position of the moving object 10 on the map, and controls the movement of the moving object 10.

The moving object 10 that autonomously operates needs high processing capability for generating the map and estimating a position of the moving object 10 on the map based on the information of the distance sensor information. Thus, the cost per moving object is high, and it is difficult to work moving objects 10.

On the other hand, the moving object 10 that is a control target of the server according to the first embodiment operates in response to a control signal from the server. In this case, processing corresponding to the map generator 14, the position estimator 15, and the movement controller 16 is performed by the server.

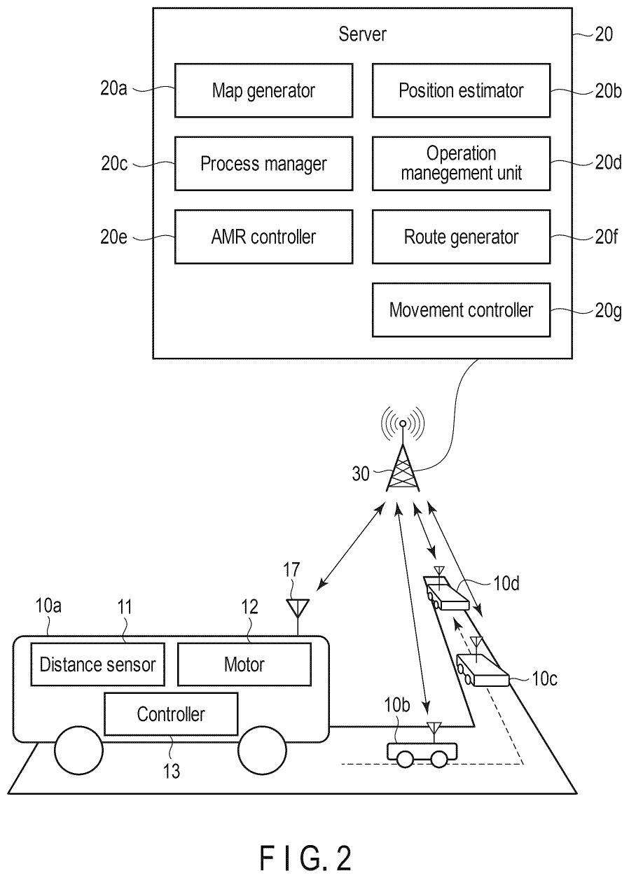

FIG. 2 is a diagram illustrating a basic configuration example of a server 20 according to the first embodiment.

Moving objects 10a to 10d are wirelessly connected to the server 20 via a base station 30 installed in the target space. Hereinafter, signals transmitted from the moving objects 10a to 10d to the server 20 will be referred to as “uplink signals”. The uplink signal will also be referred to as an uplink. Signals transmitted from the server 20 to the moving objects 10a to 10d will be referred to as “downlink signals”. The downlink signal will also be referred to as a downlink. Examples of the downlink signals are control signals and synchronization signals. The control signals are signals for controlling a work and a movement of the moving objects 10a to 10d. The synchronization signals are signals for synchronizing between the moving objects 10a to 10d and the base station 30 (server 20).

The moving object 10a includes the distance sensor 11, a motor 12, a controller 13, and a wireless device 17. The controller 13 controls the motor 12 based on a control signal transmitted from the server 20. Furthermore, the controller 13 calculates a moving distance based on a rotation amount of the wheel and a direction of the wheel.

The wireless device 17 transmits the distance sensor information and the moving distance to the server 20 via the base station 30, and receives a control signal from the server 20 via the base station 30. Note that, although not illustrated, each of the moving objects 10b to 10d also includes the distance sensor 11, a motor, a controller, and a wireless device, similarly to the moving object 10a.

The server 20 includes, for example, a map generator 20a, a position estimator 20b, a process manager 20c, an operation management unit 20d, an autonomous mobile robot (AMR) controller 20e, a route generator 20f, and a movement controller 20g.

The map generator 20a generates a map based on the distance sensor information and the moving distance transmitted by the moving objects 10a to 10d. The position estimator 20b estimates positions of the moving objects 10a to 10b on the map generated by the map generator 20a.

The process manager 20c manages a process (procedure) such as work performed by the moving objects 10a to 10d.

The operation management unit 20d manages the order of movement and the like of each of the moving objects 10a to 10d based on a work performed by the moving objects 10a to 10d.

The route generator 20f generates routes of the moving objects 10a to 10d based on the order of work performed by the moving objects 10a to 10d and the positions of the moving objects 10a to 10d.

The AMR controller 20e generates control signals for performing a work at the positions of the moving objects 10a to 10d estimated by the position estimator 20b.

The movement controller 20g generates control signals for controlling the movement of the moving objects 10a to 10d based on the route generated by the route generator 20f.

The generated control signals respectively are transmitted to the moving objects 10a to 10d via the base station 30.

As described above, the cost of the moving objects 10a to 10d can be reduced by the server 20 aggregating the generation of the map and the estimation processing of the positions of the moving objects 10a to 10d on the map. Hereinafter, a system in which the server 20 aggregates information of the moving objects 10a to 10d will be referred to as “aggregation control”.

In addition, in a case where the moving objects 10a to 10d move on a straight line in a limited range along the passage, simple control may be performed by the moving objects 10a to 10d that autonomously move. However, in a case where it is necessary to perform advanced movement such as bending a curve or avoiding an obstacle, more advanced control is required for the moving object. In particular, in a case where a large number of moving objects are controlled, positions and the like of other moving objects need to be considered, and thus the advanced control as described above is more needed. According to the aggregation control, since the information regarding the routes and positions of the moving objects 10a to 10d can be collectively ascertained, the operations of the moving objects 10a to 10d can be optimized.

Furthermore, in a case where a control signal for performing such advanced control is received by wired communication, there are at least two problems. The first problem is that the control is limited to control in a range in which a line (cord) reaches. The second problem is that the control becomes ineffective due to disconnection, and that the line gets entangled. On the other hand, when the control signal is received by wireless communication as illustrated in FIG. 2, these problems are solved. This wireless communication can be realized by, for example, a wireless LAN or private 5G.

Next, processing of estimating positions of the moving objects 10a to 10d on the map will be briefly described.

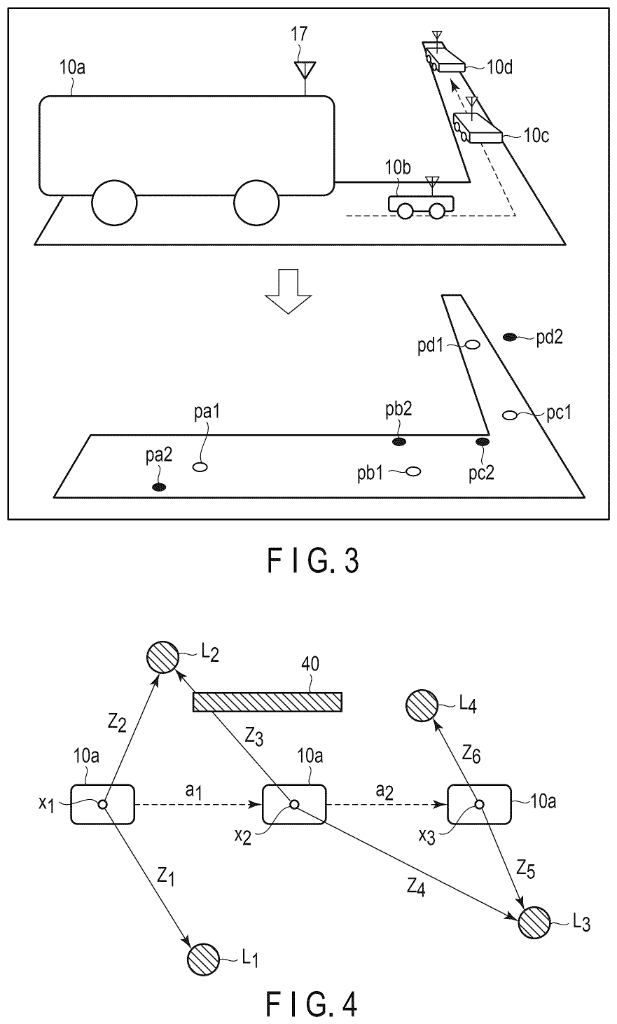

FIG. 3 is a diagram illustrating actual positions of the moving objects 10a to 10d and estimated positions of the moving objects 10a to 10d on the map estimated by the server 20. The upper part of FIG. 3 illustrates a state in which the moving objects are moving on a predetermined route.

The moving objects 10a to 10d acquire distance sensor information while moving in the space. The acquired distance sensor information and moving distances are transmitted to the base station 30. The distance sensor information includes distances between the moving objects 10a to 10d and surrounding walls, and distances between the moving objects 10a to 10d and obstacles, and the like.

The map generator 20a of the server 20 estimates a map based on the distance sensor information of the moving objects 10a to 10d received via the base station 30. The position estimator 20b estimates positions of the moving objects 10a to 10d on the map based on the distance sensor information of the moving objects 10a to 10d received via the base station 30.

However, even though moving object 10a is actually at a position pa1 on the map, a position pa2 may be estimated. Similarly, positions pb2, pc2, and pd2 of the moving objects on the map estimated by the server 20 may be different from actual positions pb1, pc1, and pd1 of the moving objects 10b, 10c, and 10d.

This is because, in the target space, an environment when the map is generated is different from an environment when the moving objects 10a to 10d are actually moving due to a layout change, movement of a person in the vicinity of the moving objects 10a to 10d, a change in a cargo load, and the like.

Here, the principle of simultaneous localization and mapping (SLAM) will be briefly described with reference to FIG. 4. SLAM is a technique generally used as a method of simultaneously estimating a map and positions of the moving objects 10a to 10d on the map.

Note that, in the following description, a coordinate system based on the position of the distance sensor 11 of the moving object 10a will be referred to as a “sensor coordinate system”. An origin of the sensor coordinate system is the position of the distance sensor 11 of the moving object 10a. In addition, in the following description, a coordinate system based on a predetermined position on the map will be referred to as a “map coordinate system”. An origin of map coordinate system is the predetermined position on the map.

The moving object 10a moves in the order of positions x₁, x₂, and x₃ illustrated in FIG. 4. At the position x₁, the moving object 10a senses the surroundings of the position x₁ by using the distance sensor 11, and detects observation points (landmarks) L₁ and L₂. Thereafter, the moving object 10a moves to position x₂, and detects observation points L₂ and L₃ at the position x₂. In addition, the moving object 10a moves to position x₃, and detects observation points L₄ and L₃ at the position x₃.

The moving object 10a transmits, to the server 20, the distance sensor information and the moving distance. The distance sensor information includes distances between the moving object 10a and the observation points L₁, L₂, L₃, and L₄. The distance sensor information also includes relative positions of the observation points L₁, L₂, L₃, and L₄ viewed from the moving object 10a. The relative positions of the observation points L₁, L₂, L₃ are position vectors of the observation points L₁, L₂, L₃, and L₄ in the sensor coordinate system.

The server 20 estimates the positions of the observation points L₁, L₂, L₃, and L₄ on the map and a position of the moving object 10a on the map based on the distance sensor information and the moving distance. Here, the observation points L₁, L₂, L₃, and L₄ on the map are position vectors of the observation points L₁, L₂, L₃, and L₄ in the map coordinate system. The position of the moving object 10a on the map is a position vector of the moving object 10a in the map coordinate system.

Here, in order to reflect the observation points L₁, L₂, L₃, and L₄ in the map, it is necessary to convert the position vectors of the observation points L₁, L₂, L₃, and L₄ in the sensor coordinate system into the position vectors of the observation points L₁, L₂, L₃, and L₄ in the map coordinate system. The position vectors of the observation points L₁, L₂, L₃, and L₄ on the map coordinate system can be obtained by estimating the position vectors of the moving object 10a on the map coordinate system.

Specifically, the server 20 estimates the position vectors x₁, x₂, and x₃ of the moving object 10a in the map coordinate system by solving simultaneous equations of the following equations (1) to (8). It is assumed that the position vector x₁ is known as an initial vector indicative of an initial position of the moving object 10a.

Furthermore, the server 20 solves simultaneous equations of the following equations (1) to (8) to obtain a position vector q₁ of the observation point L₁, a position vector q₂ of the observation point L₂, a position vector q₃ of the observation point L₃, and a position vector q₄ of the observation point L₄ in the map coordinate system.

$${x}_{2} = {x}_{1} ⊕ {a}_{1} \qquad ( 1 )$$

$${x}_{3} = {x}_{2} ⊕ {a}_{2} \qquad ( 2 )$$

Here, ⊕ is the compound assignment operator.

$${q}_{1} = {R}_{1} {Z}_{1} + {t}_{1} \qquad ( 3 )$$

$${q}_{2} = {R}_{1} {Z}_{2} + {t}_{1} \qquad ( 4 )$$

$${q}_{2} = {R}_{2} {Z}_{3} + {t}_{2} \qquad ( 5 )$$

$${q}_{3} = {R}_{2} {Z}_{4} + {t}_{2} \qquad ( 6 )$$

$${q}_{3} = {R}_{3} {Z}_{5} + {t}_{3} \qquad ( 7 )$$

$${q}_{4} = {R}_{3} {Z}_{6} + {t}_{3} \qquad ( 8 )$$

Here, a₁ is a vector including information regarding a moving distance in the sensor coordinate system when the moving object 10a has moved from the position x₁ to the position x₂. The information regarding moving distance includes a distance and a direction in which the moving object 10a has moved. a₂ is a vector including information regarding a moving distance in the sensor coordinate system when the moving object 10a has moved from the position x₂ to the position x₃. The position vectors x₁, x₂, and x₃ obtained by the simultaneous equations of the equations (1) to (8) include information regarding an advancing direction θ.

R₁, R₂, and R₃ are transformation matrices from the sensor coordinate system to the map coordinate system.

Z₁ is a position vector of the observation point L₁ in the sensor coordinate system acquired at the position x₁. Z₂ is a position vector of the observation point L₂ in the sensor coordinate system acquired at the position x₁. Z₃ is a position vector of the observation point L₂ in the sensor coordinate system acquired at the position x₂. Z₄ is a position vector of the observation point L₃ in the sensor coordinate system acquired at the position x₂. Z₅ is a position vector of the observation point L₃ in the sensor coordinate system acquired at the position x₃. Z₆ is a position vector of the observation point L₄ in the sensor coordinate system acquired at the position x₃.

t₁ is a position vector obtained by excluding the advancing direction θ from the position vector x₁ in the map coordinate system. Similarly, t₂ and t₃ are position vectors obtained by excluding the advancing direction θ from the position vectors x₂ and x₃ in the map coordinate system, respectively.

The server 20 generates and updates the map based on the position of the moving object 10a on the map (the position vector of the moving object 10a in the map coordinate system) and the positions of the observation points L₁, L₂, L₃, and L₄ (position vector of the observation points L₁, L₂, L₃, L₄ in map coordinate system) obtained by the simultaneous equations of the equations (1) to (8).

As described above, in the SLAM, the position of the moving object 10a on the map is ascertained by detecting the observation points L₁, L₂, L₃, and L₄ while the moving object 10a is moving. In general, it is known that the number of simultaneous equations increases as the number of observation points detected by the moving object 10a increases, and a position of the moving object 10a on the map can be accurately estimated.

However, in a case where there is an obstacle 40 between the moving object 10a at the position x₂ and the observation point L, the moving object 10a cannot detect the observation point L₂. Therefore, the number of simultaneous equations when the server 20 estimates a position of the moving object 10a on the map decreases, and the estimation accuracy of the position of the moving object 10a on the map decreases. Furthermore, there is a possibility that the position of the obstacle 40 is calculated as the position of the known observation point L₂. As described above, due to the disposition change, the position of the moving object 10a and the position of the observation point L₂ on the map may not be correctly estimated.

Therefore, an object of the present embodiment is to improve the accuracy of estimating the positions of the moving objects 10a to 10d by detecting a change in the environment and updating the map to reflect the change in the environment.

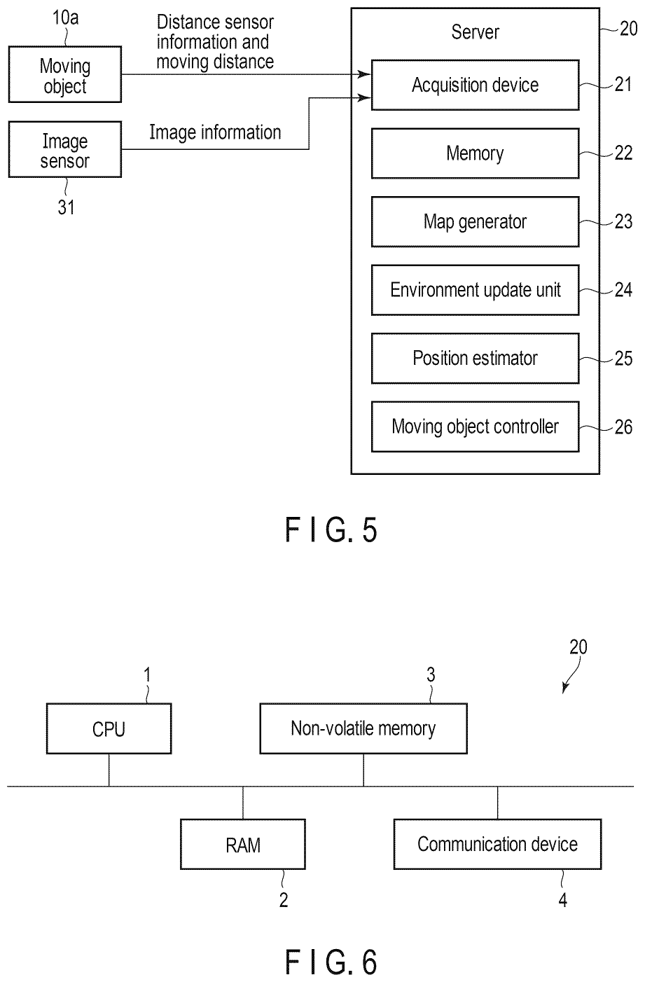

FIG. 5 is a diagram illustrating a functional configuration example of the server 20 according to the first embodiment. The server 20 according to the first embodiment is used to control the moving objects 10a to 10d moving in the target space as in the basic configuration example described above.

Here, the server 20 is connected to an image sensor 31. The image sensor 31 is, for example, a camera. The image sensor 31 is installed, for example, on a ceiling in a predetermined space, and captures an image of the inside of the predetermined space from an overhead view.

The server 20 includes an acquisition device 21, a memory 22, a map generator 23, an environment update unit 24, a position estimator 25, and a moving object controller 26. Note that the server 20 may have other constituents related to control of the moving objects 10a to 10d, such as the process manager 20c, the operation management unit 20d, the AMR controller 20e, and the route generator 20f as illustrated in FIG. 2. In addition, a form in which four moving objects 10a to 10d are controlled will be described, but the number of moving objects controlled by the server 20 may be one or two or more.

The acquisition device 21 acquires the distance sensor information and the moving distance from the moving object 10a at a predetermined cycle. Although only the moving object 10a is illustrated in FIG. 5, the acquisition device 21 also acquires (aggregates) the distance sensor information and the moving distance from the moving objects 10b to 10d at predetermined cycles.

Furthermore, the acquisition device 21 acquires image information from one or more image sensors 31 at a predetermined cycle. Note that, although one image sensor 31 is illustrated in FIG. 5, the acquisition device 21 may acquire (aggregate) image information from the one or more image sensors 31.

The memory 22 stores the information acquired by the acquisition device 21. Specifically, the memory 22 stores the distance sensor information and the moving distance. The sensor information and the moving distance are associated with identification information of the moving object that has transmitted the distance sensor information and the moving distance. The sensor information and the moving distance are also associated with the time at which the moving object has acquired the distance sensor information and the moving distance. Furthermore, the memory 22 stores information regarding an imaging range of the image sensor 31.

The map generator 23 generates a map indicating the environment of the target space based on the distance sensor information acquired in a predetermined period from the moving objects 10a to 10d and the moving distances of the moving objects 10a to 10d. The predetermined period is at least a part of a steady state period in which no environmental change has occurred in the target space. In other words, the predetermined period is a period during which the environment in the target space is managed. The map generator 23 generates a reference map by using SLAM, based on the distance sensor information and the moving distance acquired in the predetermined period.

When detecting that the environment indicated on the map has changed based on at least one of the distance sensor information and the image information acquired after the predetermined period, the environment update unit 24 updates the map while the moving objects 10a to 10d are moving. Specifically, in a case where the correlation (time correlation) between two of plurality of pieces of image information arranged in time series is low, the environment update unit 24 updates the map. Furthermore, the environment update unit 24 may update the map based on the distance sensor information acquired from the plurality of respective moving objects 10a to 10d at the same time. The map update processing will be described later in detail.

The position estimator 25 estimates the positions of the moving objects 10a to 10d on the map updated by the environment update unit 24 based on the map updated by the environment update unit 24 and at least one of the distance sensor information, the moving distance, and the image information. For example, the position estimator 25 estimates the positions of the moving objects 10a to 10d on the map by using the SLAM described above based on the map updated by the environment update unit 24 and the distance sensor information and the moving distance. Alternatively, the position estimator 25 may estimate the positions of the moving objects 10a to 10d on the map based on the map updated by the environment update unit 24 and the positions of the moving objects 10a to 10d captured in the image information.

The moving object controller 26 generates control signals for controlling the movement of the moving objects 10a to 10d and transmits the control signals to the moving objects 10a to 10d. The generated control signals are transmitted to the respective moving objects 10a to 10d via the base station 30.

FIG. 6 is a diagram illustrating a hardware configuration example of the server 20 according to the first embodiment.

The server 20 includes, for example, a central processing unit (CPU) 1, a random access memory (RAM) 2, a non-volatile memory 3, and a communication device 4.

The CPU 1 is a processor for controlling an operation of the server 20. The CPU 1 is at least one processor. The CPU 1 executes various programs loaded from the non-volatile memory 3 to the RAM 2. These programs include an operating system (OS) and various application programs. Furthermore, the server 20 may include another processor such as a graphics processing unit (GPU) in addition to the CPU 1.

The non-volatile memory 3 is a storage medium used as an auxiliary storage device. The non-volatile memory 3 can be used as a storage area for various types of information stored by the memory 22. Although only the non-volatile memory 3 is illustrated in FIG. 6, the server 20 may include other storage devices such as a hard disk drive (HDD) and a solid state drive (SSD).

The RAM 2 is a storage medium used as a main storage device. The RAM 2 may be used as a temporary storage area of data used for processing of the server 20.

The communication device 4 is a device configured to execute wireless communication with the moving objects 10a to 10d and the image sensor 31. The communication device 4 includes, for example, a receiver unit that receives uplink signals from the outside and a transmitter unit that transmits downlink signals to the outside. The receiver unit can receive signals from each of the moving objects 10a to 10d and the image sensor 31. The transmitter unit can transmit signals (for example, control signals or synchronization signals) to each of the moving objects 10a to 10d.

Note that some or all of the acquisition device 21, the memory 22, the map generator 23, the environment update unit 24, the position estimator 25, and the moving object controller 26 illustrated in FIG. 5 are realized by causing the CPU 1 to execute a predetermined program, that is, by software. This program may be stored in a computer-readable storage medium and distributed, or may be downloaded to the server 20 via a network. Note that some or all of the acquisition device 21, the memory 22, the map generator 23, the environment update unit 24, the position estimator 25, and the moving object controller 26 may be realized by dedicated hardware or the like, or may be realized by a combination of software and hardware.

Next, an outline of processing of the server 20 according to the first embodiment will be described.

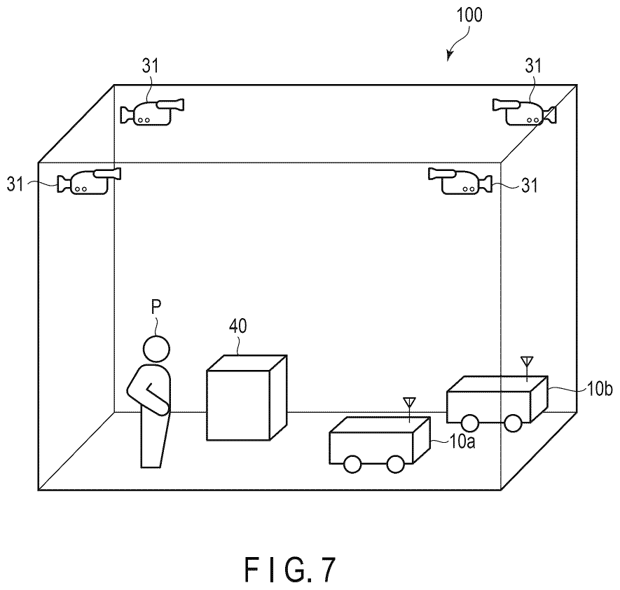

FIG. 7 is a diagram simply illustrating an example of a target space 100. The target space 100 is assumed to be, for example, a space where a person P and the obstacle 40 are present.

The two moving objects 10a and 10b move in the target space 100. Each of moving objects 10a and 10b acquires distance sensor information as surrounding environment information while moving in the target space 100. In this case, the distance sensor information obtained from the moving objects 10a and 10b is information regarding a narrow range (local viewpoint) around the moving objects 10a and 10b. For example, since the person P is hidden behind the obstacle 40 from the moving object 10b, the moving object 10b cannot acquire distance sensor information related to the person P. In addition, since the moving objects 10a and 10b are moving, it is not possible to detect the temporal transition of the obstacle 40 or the person P at a certain point.

Therefore, in the present embodiment, a plurality of image sensors 31 are installed in an upper portion of the target space 100. Each of the plurality of image sensors 31 captures an image of the target space 100 from an overhead view. According to the plurality of image sensors 31, since the entire environment of the target space 100 can be seen, the position and the temporal transition of the person P can be ascertained.

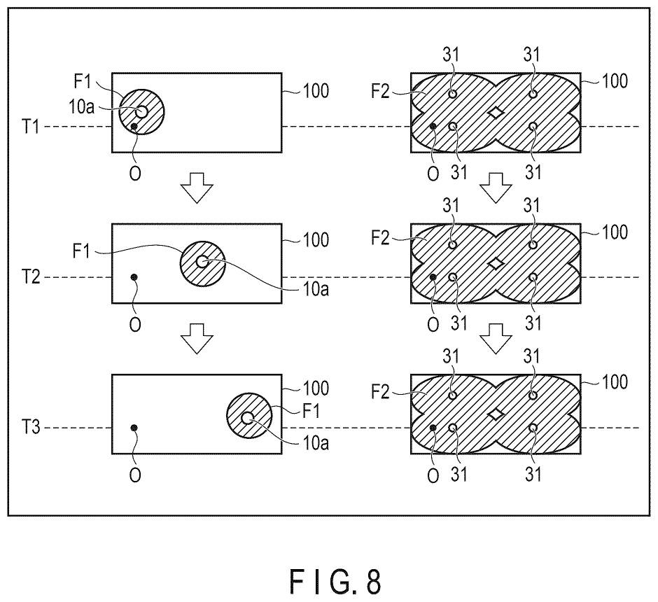

FIG. 8 is a diagram illustrating temporal change of a range of distance sensor information that can be acquired by the moving object 10a and temporal change of a range in which image information can be acquired by the plurality of image sensors 31.

F1 in the left part of FIG. 8 indicates a range of distance sensor information that can be acquired by the moving object 10a. As illustrated in the left part of FIG. 8, the range F1 of the distance sensor information that can be acquired by the moving object 10a also moves along with the movement of the moving object 10a. Therefore, an object O detected at a time point T1 is not detected at the subsequent time points T2 and T3.

On the other hand, F2 in the right part of FIG. 8 illustrates an imaging range that can be acquired by the plurality of image sensors 31. As illustrated in the right part of FIG. 8, the imaging range F2 that can be acquired by the plurality of image sensors 31 is wide, and the target space 100 can be imaged. Thus, the object O can be imaged at all of the time points T1 to T3. In other words, it is possible to track the temporal transition of the object A, and it is possible to determine whether the object O is dynamic object or static object.

Note that, in this case, the information obtained by the plurality of image sensors 31 and the information obtained by the moving objects 10a and 10b are distributed. Therefore, a mechanism for aggregating the information obtained by the plurality of image sensors 31 and the information obtained by the moving objects 10a and 10b is required.

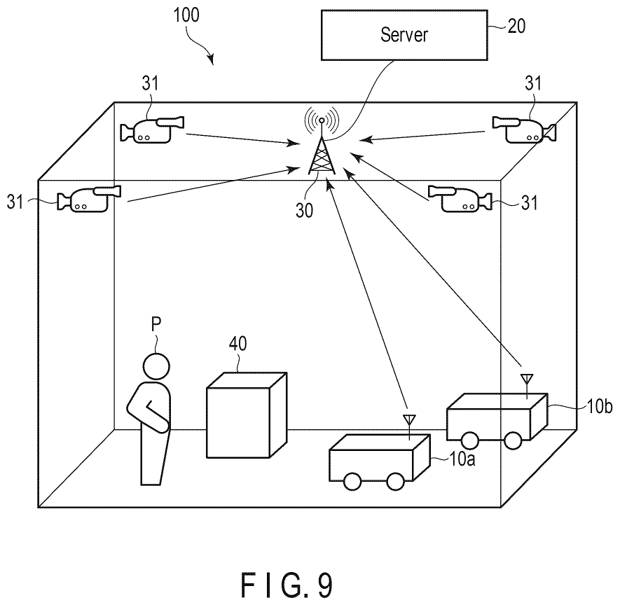

Therefore, as illustrated in FIG. 9, the server 20 according to the present embodiment acquires the distance sensor information that can be acquired by the moving objects 10a and 10b as well as the information regarding the imaging range that can be acquired by the plurality of image sensors 31. Thereby, the server 20 detects the change in the environment of the target space 100 and updates the map. Furthermore, the server 20 estimates positions of the moving objects 10a and 10b based on the updated map.

Here, communication among the server 20, the moving objects 10a and 10b, and the plurality of image sensors 31 is performed via high-speed and low-delay communication such as private 5G. According to the high-speed and low-delay communication, since the server 20 can transmit and receive information to and from the moving objects 10a and 10b and the plurality of image sensors 31 without delay, the moving objects 10a to 10d can operate as if the moving objects 10a to 10d themselves estimate positions on the map and move autonomously.

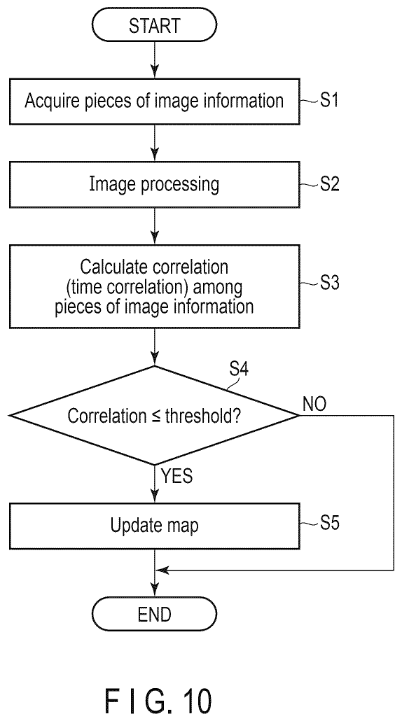

FIG. 10 is a flowchart illustrating an example of map update processing of the server 20 according to the first embodiment. Note that, in a case where there are a plurality of image sensors 31, the map update processing illustrated in FIG. 10 is performed for each of the plurality of image sensors 31.

The acquisition device 21 of the server 20 acquires a plurality of pieces of image information from the image sensors 31 at predetermined time intervals (in time series) within a predetermined period (step S1). The predetermined period is a period shorter than the predetermined time intervals.

The environment update unit 24 performs image processing on each of the plurality of pieces of image information acquired in step S1 to identify an object shown in the image information (step S2). Semantic segmentation is used to identify an object, for example. Semantic segmentation is a technology of assigning a label to each pixel of image information based on a feature learned in advance.

The environment update unit 24 calculates a correlation value (that is, time correlation) among the plurality of pieces of image information to which the labels are assigned (step S3). A method of calculating a correlation value of the plurality of pieces of image information may be any method. For example, the environment update unit 24 may calculate the correlation value by referring to each pixel among the plurality of pieces of image information and comparing labels assigned to the pixels.

The environment update unit 24 determines whether the correlation value among the plurality of pieces of image information is equal to or less than a predetermined threshold (step S4). The fact that the correlation value among the plurality of pieces of image information is great indicates that the pieces of image information are similar to each other. That is, there is a high possibility that the environment of the range indicated by the image information has not changed. On the other hand, the fact that the correlation value of the plurality of pieces of image information is small indicates that the pieces of image information are dissimilar. That is, there is a high possibility that an environment of a range indicated by the image information has changed.

In step S4, in a case where the correlation value is greater than the predetermined threshold (NO in step S4), there is no change in the environment, and thus the server 20 ends the map update processing without updating the map.

On the other hand, in step S4, in a case where the correlation value is equal to or smaller than the predetermined threshold (YES in step S4), the environment update unit 24 detects that there is a change in the environment, and updates the map (step S5).

For example, the environment update unit 24 identifies a type (point cloud) of a portion that has changed among the plurality of pieces of image information. Specifically, the environment update unit 24 determines whether a portion that has changed among the plurality of pieces of image information is a portion where the object already indicated in the map has moved (known point cloud) or a new object that has not been indicated in the map (unknown point cloud), based on the information regarding the label assigned to each pixel of the plurality of pieces of image information. In addition, it is determined whether the portion is a static object (static point cloud) or a dynamic object (dynamic point cloud) based on whether a position of the portion that has changed among the plurality of pieces of image information has changed.

The environment update unit 24 reflects the determined object (static point cloud and dynamic point cloud) in the map to update the map. Note that the environment update unit 24 performs processing of converting the position of the object on the image into a position of the object on the map based on the imaging range F1 of the image sensor 31.

As described above, the server 20 according to the first embodiment detects a change in the environment based on the image information from the image sensor 31 and updates the map. By using the image information in the overhead view, even an object at a position that cannot be detected by the distance sensors 11 of the moving objects 10a to 10d can be reflected in the map. Furthermore, since the temporal transition of an object can be tracked, it is possible to easily ascertain whether an object that has changed is a known point cloud or an unknown point cloud, and whether the object is a static object or a dynamic object.

According to the server 20 of the present embodiment, since the change in the environment can be reflected in the map, the estimation accuracy of the positions of the moving objects 10a to 10d on the map can be improved. For example, as illustrated in FIG. 4, even when the obstacle 40 is placed, it is possible to prevent malfunctions such as calculating the obstacle 40 as the observation point L₂ by reflecting the position of the obstacle 40 in the map. Furthermore, if it can be ascertained that the obstacle 40 is an unknown and a static object, the positions of the moving objects 10a to 10d on the map can be calculated with the obstacle 40 as a new observation point. As described above, the estimation accuracy of the positions of the moving objects 10a to 10d on the map can be improved by updating the map.

Furthermore, according to the server 20 of the present embodiment, it is possible to update the map while working (operating) the moving objects 10a to 10d instead of regenerating the map. As a result, the estimation accuracy of the positions of the moving objects 10a to 10d can be improved without lowering the overall operation efficiency.

Note that the server 20 according to the present embodiment is connected to the plurality of moving objects 10a to 10d and the plurality of image sensors 31. Therefore, the server 20 may update the map by generating a plurality of maps based on information acquired from each of the plurality of moving objects 10a to 10d and the plurality of image sensors 31 and aggregating the plurality of maps.

Specifically, the server 20 generates a plurality of maps corresponding to the respective moving objects 10a to 10d based on a plurality of pieces of distance sensor information acquired from the respective moving objects 10a to 10d. In addition, a plurality of maps respectively corresponding to plurality of image sensors 31 are generated based on a plurality of pieces of image information acquired from the respective plurality of image sensors 31. The generated plurality of maps are compared to generate a new map. The environment (the position of the object or the like) indicated in the new map is updated such that an error is reduced.

The map based on such a large amount of information is updated, and thus a more accurate map can be generated. As a result, the estimation accuracy of the positions of the moving objects 10a to 10d on the map can be improved.

### Second Embodiment

Next, a second embodiment will be described.

FIG. 11 is a diagram illustrating a functional configuration of a server 20A. The server 20A includes the acquisition device 21, the memory 22, the map generator 23, the environment update unit 24, a position estimator 25A, and the moving object controller 26. The server 20A is different from the server 20 according to the first embodiment described above in further acquiring received power information from the moving objects 10a to 10d and detecting a change in an environment based on the received power information.

The received power information includes the strengths of signals received by the moving objects 10a to 10d and the time at which the signals are received. Here, the moving objects 10a to 10d receive interference signals in addition to downlink signals (control signals or synchronization signals) transmitted from the server 20.

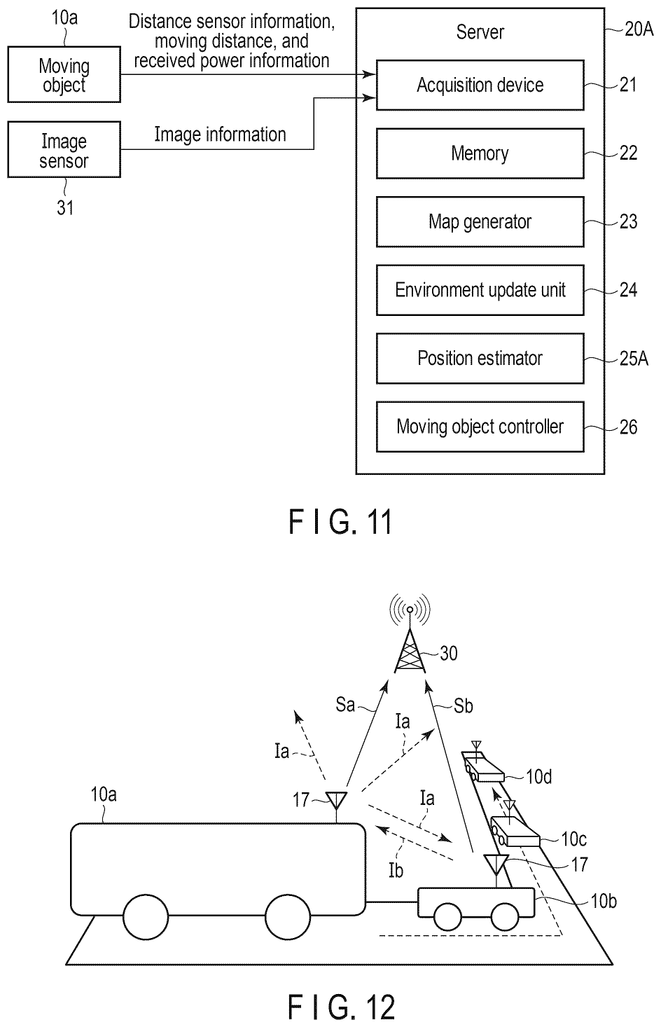

The interference signal in the present embodiment is an uplink signal of a certain moving object among the moving objects 10a to 10d received by another moving object when the certain moving object transmits the uplink signal. The interference signal will be described later with reference to FIG. 12. In addition, the memory 22 included in the server 20 further stores information regarding the strength of the interference signal and the strength of the downlink signal. The strength of the interference signal is stored in association with a time and a position at which the interference signal is received. The strength of the downlink signal is stored in association with a time and a position at which the downlink signal is received.

Further, in the memory 22, interference information indicating the strength of an interference signal between two of the moving objects 10a to 10d is stored in advance. The interference information is the strength of the interference signal in a state in which there is no object between two of the moving objects 10a to 10d and each of the moving objects 10a to 10d is separated by a predetermined distance. For example, in the above state, the interference information indicates the strength of the interference signal received by each of the other moving objects 10b to 10d when the moving object 10a transmits the uplink signal, the strength of the interference signal received by the other moving objects 10a, 10c, and 10d when the moving object 10b transmits the uplink signal, the strength of the interference signal received by the other moving objects 10a, 10b, and 10d when the moving object 10c transmits the uplink signal, and the strength of the interference signal received by the other moving objects 10a to 10c when the moving object 10d transmits the uplink signal.

Hereinafter, the interference signal will be described with reference to FIG. 12. The moving object 10a transmits an uplink signal Sa including distance sensor information and a moving distance to the base station 30 (specifically, the server 20 connected to the base station 30). In this case, it is ideal that a radio wave of the uplink signal Sa is linearly radiated toward the base station 30. However, an actual radio wave of the uplink signal Sa is radiationally radiated around the moving object 10a. As a result, the moving objects 10b to 10d other than the moving object 10a receive a signal Ia that is a leak of the uplink signal Sa.

Similarly, when an uplink signal Sb is transmitted by the moving object 10b, a signal Ib is radiated around the moving object 10b. The moving objects 10a, 10c, and 10d other than the moving object 10b receive the signal Ib that is a leak of the uplink signal Sb. The same applies when the other moving object 10c or 10d transmits the uplink signal.

In the present embodiment, communication (inter-terminal direct communication) between two of the moving objects 10a to 10d is not intended. That is, the signals Ia and Ib are interference signals that may interfere with the uplink signals Sa and Sb transmitted by the respective moving objects and downlink signals received by the respective moving objects.

Even if the moving objects 10a to 10d receive the interference signal, the moving objects cannot acquire information included in the interference signal. However, the moving objects 10a to 10d can measure the strength (received power) of the interference signal. The server 20 according to the present embodiment detects a change in surrounding environment information by using information regarding the strength of the interference signal.

Hereinafter, for example, an interference signal received by the moving object 10b when the moving object 10a transmits an uplink signal or an interference signal received by the moving object 10a when the moving object 10b transmits an uplink signal may be referred to as an “interference signal between the moving object 10a and the moving object 10b”.

Here, an example of a method of measuring the strength of the interference signal will be described. For example, in a form (time division duplex (TDD)) in which an uplink signal and a downlink signal are distinguished by reception time, measurement of the strength of the interference signal between the moving object 10a and one of the other moving objects 10b to 10d will be described.

In this case, when the moving object 10a transmits an uplink signal at a timing at which the server 20 (base station 30) does not transmit a downlink signal to any of the moving objects 10a to 10d, the moving objects 10b to 10d can measure the strength of the interference signal between the moving object 10a and each of the moving objects 10b to 10d by measuring, for example, a received signal strength indicator (RSSI) or a signal to interference ratio (SIR).

Alternatively, in a form (full duplex) in which wireless devices 17 of the moving objects 10a to 10d can simultaneously transmit an uplink signal and receive a downlink signal, and in a case where timings of the transmission of the uplink signal and the reception of the downlink signal overlap, the moving objects 10b to 10d may measure both an SIR when the moving object 10a transmits the uplink signal and a signal to noise ratio (SNR) when the moving object 10a does not transmit the uplink signal. Thereby, the moving objects 10b to 10d measure the strength of the interference signal between the moving object 10a and each of the other moving objects 10b to 10d by comparing the SIR with the SNR.

Furthermore, in a case where the wireless device 17 of each of the moving objects 10a to 10d has an array antenna, the interference signal may be identified through arrival direction estimation. The arrival direction estimation is a technology of estimating a direction in which a signal is received based on a time difference (phase difference) in the signal received by respective elements of the array antenna. In a case where the received signal is received from a direction other than the installation position of the base station 30, the moving objects 10a to 10d determine that the received signal is the interference signal due to transmission of an uplink signal by another moving object. Then, the moving objects 10a to 10d measure the strength of the signal as the strength of the interference signal. Normally, in the arrival direction estimation, a null is formed for the interference signal. However, for example, the interference signal can be acquired by focusing on an eigenvalue and an eigenvector of a correlation matrix and using a second eigenvector as a weight of the antenna instead of the first eigenvector. In this case, the moving objects 10a to 10d transmit the received power information including information regarding the direction in which the interference signal has been received. The server 20A determines that the interference signal is generated between which moving objects based on the information regarding the direction and the positions of the moving objects 10a to 10d on the map estimated by the position estimator 25A.

Note that, in order to measure the strength of the interference signal more accurately, the wireless device 17 of a specific moving object may be set to a sleep state. Specifically, for example, when the strength of the interference signal between the moving object 10a and the moving object 10b is measured, the wireless devices 17 of the moving objects 10c and 10d other than the moving object 10a and the moving object 10b are set to a sleep state (that is, a state in which a signal is not transmitted).

In addition, a method of measuring the strength of the interference signal is not limited to the above-described method, and any other method such as using a predetermined filter may be used.

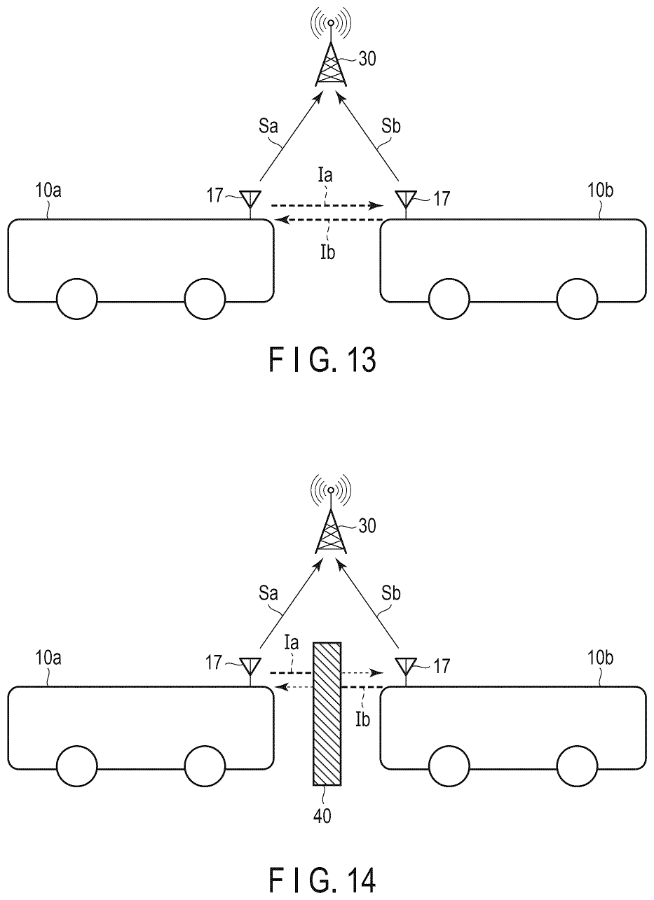

Next, an outline of a method of detecting a change in the surrounding environment according to the second embodiment will be described with reference to FIGS. 13 and 14. FIGS. 13 and 14 illustrate a state in which two moving objects, for example, 10a and 10b stop and face each other.

There is no obstacle between the moving object 10a and the moving object 10b illustrated in FIG. 13. In this case, the moving object 10a receives the interference signal Ib when the moving object 10b transmits the uplink signal Sb to the base station 30. Similarly, the moving object 10b receives the interference signal Ia when the moving object 10a transmits the uplink signal Sa to the base station 30. Information regarding the strengths of the interference signals Ia and Ib is included in the uplink signals Sa and Sb, respectively, and transmitted to the base station 30 (server 20).

Thereafter, it is assumed that the environment between the moving object 10a and the moving object 10b changes, and the obstacle 40 is disposed between the moving object 10a and the moving object 10b as illustrated in FIG. 14.

In this case, when the moving object 10b transmits the uplink signal Sb to the base station 30, the moving object 10a receives the interference signal Ib attenuated by the obstacle 40. Similarly, when the moving object 10a transmits the uplink signal Sa to the base station 30, the moving object 10b receives the interference signal Ia attenuated by the obstacle 40.

That is, the strengths of the interference signals Ia and Ib between the moving object 10a and the moving object 10b change according to the environment between the moving object 10a and the moving object 10b. In the present embodiment, by detecting this change, a change in the environment between the moving object 10a and the moving object 10b is detected.

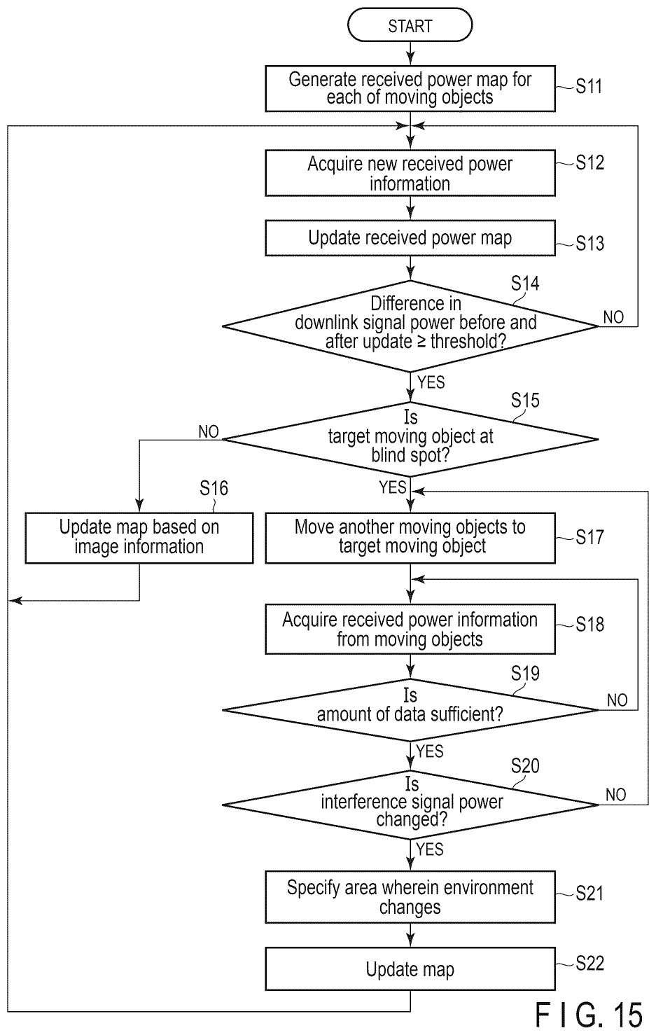

FIG. 15 is a flowchart illustrating an example of a flow of map update processing of the server 20 according to the second embodiment.

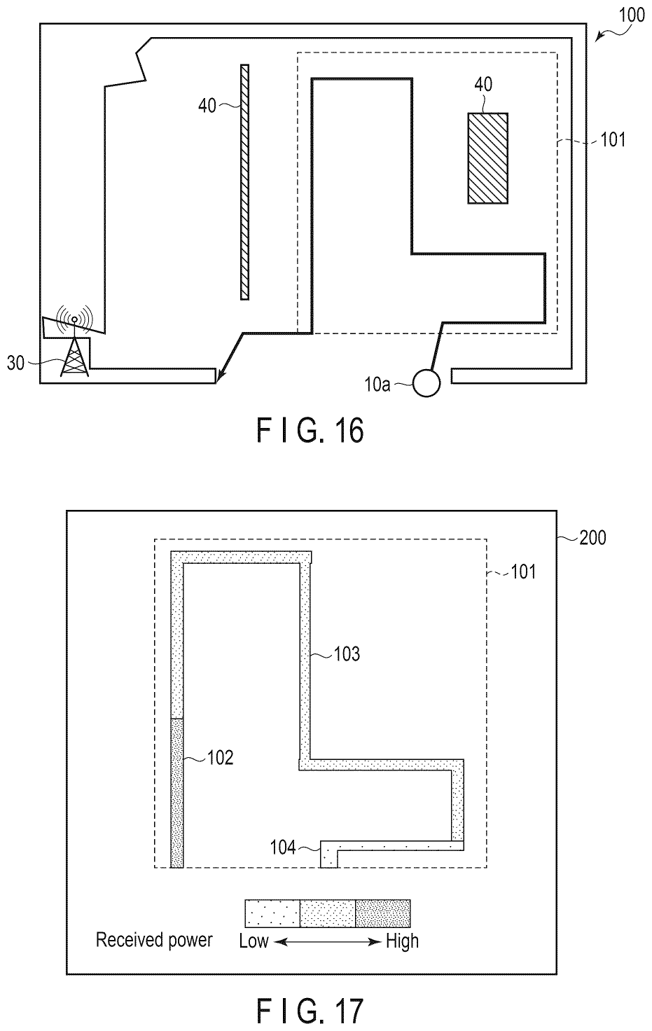

An environment update unit 24A generates a received power map of each of the moving objects 10a to 10d (step S11). The received power map is a map indicating positions of the moving objects 10a to 10d on the map and the strengths of downlink signals (control signals or synchronization signals) received by the moving objects 10a to 10d at the positions. Here, the received power map will be described with reference to FIGS. 16 and 17. In the following description, the received power map of the moving object 10a will be described, but the same applies to the received power maps of the other moving objects 10b to 10d.

For example, as illustrated in FIG. 16, it is assumed that the moving object 10a moves along a predetermined route in the target space 100. The moving object 10a receives a downlink signal from the base station 30 at each position on the movement route. In addition, the moving object 10a transmits, to the base station 30, received power information including the strength of the downlink signal and the time at which the moving object 10a has received the downlink signal.

The environment update unit 24 maps the strength of the downlink signal received by the moving object 10a in association with the position where the moving object 10a has received the downlink signal, thereby generating the received power map as illustrated in FIG. 17, for example.

FIG. 17 is an example of the received power map 200 generated for a partial area 101 in the target space 100 illustrated in FIG. 16. In an area 102, the strength of the downlink signal received by the moving object 10a is high. In an area 103, the strength of the downlink signal received by the moving object 10a is lower than the moving object 10a in an area 102. In an area 104, the strength of the downlink signal received by the moving object 10a is lower than the moving object 10a in an area 103. Note that the position where the moving object 10a has received the downlink signal is a position of the moving object 10a on the map estimated by the position estimator 25A at the time at which the moving object 10a has received the downlink signal. The received power map 200 may be generated at the same time when, for example, the map generator 23 generates the reference map.

The description returns to FIG. 15. The environment update unit 24 acquires new received power information from each of the moving objects 10a to 10d along with the movement of each of the moving objects 10a to 10d (step S12).

When the received power information has been acquired, the environment update unit 24 updates the received power map generated in step S11 (step S13). Specifically, for example, when the received power information is received from the moving object 10a, the environment update unit 24 refers to a position on the received power map corresponding to the position where the moving object 10a has received the downlink signal, and updates the information regarding the strength of the downlink signal mapped to the position. The same applies to a case where the received power information is received from the other moving objects 10b to 10d. Hereinafter, a moving object that has transmitted the received power information will be referred to as a “target moving object”. Further, a position on the received power map 200 corresponding to the position where the target moving object has received the downlink signal will be referred to as a “target position”.

Further, the environment update unit 24 determines whether or not the information regarding the strength of the downlink signal at the target position has changed by a threshold or more. In other words, the environment update unit 24 determines whether or not a difference between the information regarding the strength of the downlink signal at the target position before the update and the information regarding the strength of the downlink signal at the target position after the update is equal to or more than the threshold (step S14).

The fact that the information regarding the strength of the downlink signal at the target position has changed indicates that a route (propagation route) through which the target moving object receives radio waves from the base station 30 has changed. That is, there is a high possibility that an object that causes a change in the propagation route exists around the target position (target moving object). Hereinafter, the object that causes a change in the propagation route will be referred to as an “environmental variation factor”.

In a case where it is determined in step S14 that the information regarding the strength of the downlink signal at the target position has not changed by the threshold or more (NO in step S14), there is a low possibility that there is the environmental variation factor, and thus the environment update unit 24 returns to the processing in step S12.

On the other hand, in a case where it is determined in step S14 that the information regarding the strength of the downlink signal at the target position has changed by the threshold or more (YES in step S14), the environment update unit 24 determines whether or not the target position is included in a range in which image information cannot be acquired by the image sensor 31. In other words, the environment update unit 24 determines whether or not the target moving object is at a blind spot of the image sensor 31 (step S15). That is, since there is a high possibility that the environment has changed in the vicinity of the target moving object, it is determined whether or not the image information in the vicinity of the target moving object can be acquired.

When the target moving object is not at a blind spot of the image sensor 31 (NO in step S15), the environment update unit 24 estimates a position of the environmental variation factor based on the image information including the target position acquired by the image sensor 31, and updates the map based on image information (step S16). A map update method based on the information from the image sensor 31 is similar to that of the first embodiment described above. After updating the map, the server 20 returns to the processing in step S12.

On the other hand, when the target moving object is at a blind spot of the image sensor 31 (YES in step S15), the moving object controller 26 moves a moving object other than the target moving object toward the target moving object (the target position) by a first distance (step S17). An examples of the first distance is a body length of the moving objects 10a to 10d, or half or twice of the body length. If the target space 100 is a rectangular area, an example of the first distance is several percent of the width, the length, or the diagonal of the target space 100. Moving objects that are caused to move toward the target moving object may be all moving objects other than the target moving object, or may be a certain moving objects other than the target moving object. Here, the description will be made on the assumption that the moving object controller 26 has caused all moving objects 10a to 10d other than the target moving object to move toward the target position.

The environment update unit 24 acquires the received power information from the moving objects 10a to 10d again (step S18). Specifically, in response to the control signals from the moving object controller 26, the moving objects 10a to 10d receive the interference signal between two of the moving objects 10a to 10d. The moving objects 10a to 10d transmit the uplink signal including the strength of the interference signal. The environment update unit 24 acquires information regarding the strength of the interference power between two of the moving objects 10a to 10d via the acquisition device 21.

The environment update unit 24 determines whether the acquired data amount is sufficient (step S19). The sufficient data amount is, for example, the number of links between the respective moving objects 10a to 10d. Specifically, the sufficient data amount is the number 4 choose 2 of combinations of selecting two of four. In a case where there are n moving objects, it is the number of n choose 2. Note that, in a case where it is determined whether the environmental variation factor is a dynamic object or a static object, it is necessary to acquire the strength of the interference signal in the predetermined period and detect whether there is a change. Therefore, the sufficient data amount is a predetermined multiple of the number of links between two of the moving objects 10a to 10d. For example, in a case where the strength of the interference signal is acquired at 100 times/second for 10 seconds, the sufficient data amount is n choose 2×1000.

When it is determined in step S19 that the acquired data amount is not sufficient (NO in step S19), the environment update unit 24 returns to the processing in step S18 and further acquires information regarding the strength of the interference power.

In a case where it is determined in step S19 that the acquired data amount is sufficient (YES in step S19), the environment update unit 24 refers to the interference information stored in the memory 22 and determines whether or not a change (variation amount) is detected in the strength of the interference signal between two of the plurality of moving objects (step S20). For example, in a case where the strength of the interference signal between the moving object 10a and the moving object 10b is different from the interference information stored in the memory 22, it is possible to detect that there is a change in the environment between the moving object 10a and the moving object 10b (that is, there is the environmental variation factor). Determination as to whether the environmental variation factor is a dynamic object or a static object may be performed together.

In step S20, in a case where the variation amount is not detected (NO in step S20), the server 20 returns to the processing in step S17, and repeats acquiring the strength of the interference signal by causing the moving object to move to the moving object. This is because there is no change in the environment among the current moving objects 10a to 10d, but there is a possibility that a change in the environment can be detected by causing the moving objects 10a to 10d to move and changing positions of the links between two of the moving objects 10a to 10d.

Note that, in a case where no change is detected even when the processing in steps S17 to S20 is repeated a predetermined number of times, the server 20 may determine that no change in the environment has occurred, transmit a control signal for returning to a normal route to the moving objects 10a to 10d without updating the map, and return to the processing in step S12.

In a case where the variation amount is detected in step S20 (YES in step S20), the environment update unit 24 specifies an area in which the environment has changed based on the variation amount (step S21). Specifically, for example, in a case where the strength of the interference signal between the moving object 10a and the moving object 10b is different from the interference information stored in the memory 22, the area between the moving object 10a and the moving object 10b is specified as an area where the environment has changed. That means there is the environmental variation factor.

Thereafter, the environment update unit 24 updates the map based on the area specified in step S21 (step S22). For example, the environment update unit 24 causes the moving objects 10a to 10d to further move by using the control signals from the moving object controller 26, and further acquires distance sensor information in the area specified in step S21.

Alternatively, the environment update unit 24 causes another moving object equipped with a sensor with good performance (for example, a sensor capable of acquiring three-dimensional information) to move to the target object by using the control signal from the moving object controller 26, and acquires detailed information.

The environment update unit 24 estimates a position of the environmental variation factor in the area specified in step S21 by using a method such as the SLAM described above based on the sensor information, and updates the map. The environment update unit 24 may determine whether an object that is the environmental variation factor is a dynamic object or a static object, and unknown object or known object, and reflect these pieces of information (point cloud) in the map. In addition, the environment update unit 24 may specify the environmental variation factor by using a learning model that has been trained in advance to predict an object from waveforms of the downlink signals or the interference signals received by the moving objects 10a to 10d.

After the map is updated, the moving object controller 26 transmits the control signal for returning to the normal route to the moving objects 10a to 10d. server 20A returns to the processing in step S12 and repeats the subsequent processing.

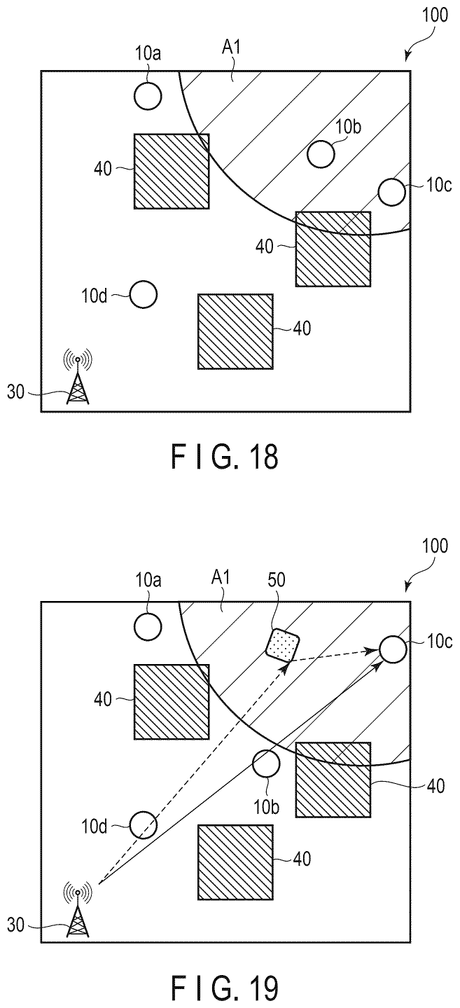

Next, a specific example of a case where the server 20 according to the second embodiment is applied will be described with reference to FIGS. 18 to 21.

In FIGS. 18 to 21, it is assumed that the moving objects 10a to 10d move in the target space 100 in which the known obstacles 40 are disposed. The moving objects 10a to 10d receive the downlink signals (control signals or synchronization signals) from the base station 30 connected to the server 20, and the transmit uplink signals including the distance sensor information, the moving distance, and the received power information to the base station 30. In addition, an area A1 indicates a range in which an image information cannot be acquired by the image sensor 31 (that is, the blind spot of the image sensor 31).

Here, as illustrated in FIG. 19, it is assumed that a static unknown object 50 (that is, the environmental variation factor) is installed in the vicinity between the base station 30 and the moving object 10c. In this case, the downlink signal transmitted from the base station 30 is reflected by the object 50 and received by the moving object 10c. That is, the strength of the downlink signal received by the moving object 10c changes. By detecting the change in the strength of the downlink signal, the server 20 can detect that the environment has changed on the propagation route of the downlink signal.

However, in a case where a distance between the moving object 10c and the base station 30 is long, it is difficult to specify a specific position where the environment has changed. In addition, there is a possibility that the change in the strength of the downlink signal is not a change in the environment and another moving object blocks the propagation route.

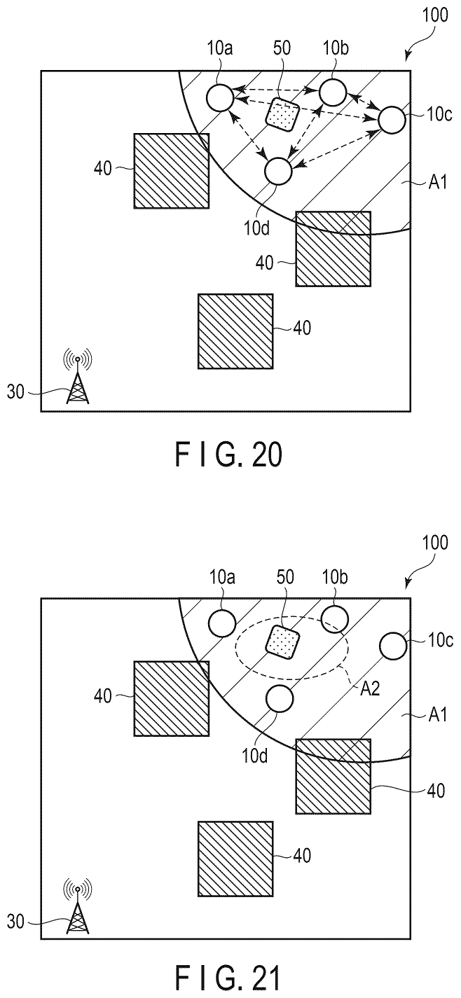

Therefore, as illustrated in FIG. 20, the server 20 according to the present embodiment causes the moving objects 10a, 10b, and 10d move (to be disposed) toward the moving object 10c. The server 20A causes the moving objects 10a to 10d to receive the interference signals between two of the moving objects 10a to 10d, and receives the information regarding the interference signals.

In the example in FIG. 20, the interference signal between the moving object 10a and the moving object 10c is blocked by the object 50. Therefore, the strength of the interference signal between the moving object 10a and the moving object 10c is different (changes) from the strength of the interference signal between the moving object 10a and the moving object 10c indicated in the interference information stored in advance in the memory 22. Therefore, by detecting this change, the server 20 can specify an area where there is the environmental variation factor.

In the example illustrated in FIG. 21, the server 20 specifies an area A2 between the moving object 10a and the moving object 10c as an area where the environment has changed (there is the environmental variation factor).

Thereafter, the server 20 causes the moving objects 10a to 10d to move toward the vicinity of the specified area A2 and acquires the distance sensor information and the like in the area A2. Then, the server 20 estimates a position of the object 50 and reflects the position in the map.

As described above, the server 20 according to the second embodiment acquires the received power information from each of the moving objects 10a to 10d, and detects a change in the environment based on the received power information. Specifically, when detecting a change in the strength of the interference signal between two of the moving objects 10a to 10d, the server 20 detects a change in the environment.

According to the server 20 of the second embodiment, for example, even in a case where the number of installed image sensors 31 is limited and the image information in the entire range of the target space 100 cannot be acquired, it is possible to update the map by detecting a change in the environment based on the received power information.

In addition, in the second embodiment, an area where there is an environmental variation factor is specified based on a change in the strength of an interference signal. For example, in a case where a distance between the base station 30 and each of the moving objects 10a to 10d is long, it is difficult to specify an area where there is an environmental variation factor only based on changes in the strengths of communication signals (uplink signals or downlink signals) between the base station 30 and each of the moving objects 10a to 10d. In addition, a possibility that the environmental variation factor is another moving object cannot be excluded. According to the present embodiment, since an area where there is an environmental variation factor can be specified based on a change in the strength of an interference signal, it is possible to efficiently estimate a position of the environmental variation factor and update the map.

Note that, in the above description, it has been described that a change in the environment is detected by combining the image sensor 31 and the received power information. The server 20A may detect a change in the environment only based on the received power information without using the image sensor 31. That is, after detecting a change in the strength of a downlink signal received by the target moving object, the server 20 may cause another moving object to move to the surroundings of the target moving object without performing the determination processing (the processing in step S15 illustrated in FIG. 15) as to whether or not the range is a range in which the image information can be acquired by the image sensor 31. In this case, the server 20 specifies the area based on the received power information (the strength of the interference signal) of the moving object, and updates the map based on the distance sensor information and the moving distance.

In addition, even in a range in which the image information can be acquired by the image sensor 31, processing of causing another moving object to move to the surroundings of the target moving object and specifying an area based on received power information (the strength of an interference signal) of the moving object (processing in steps S17 to S21 illustrated in FIG. 15) may be performed. In this case, the map may be updated based on not only the distance sensor information and the moving distance but also the image information in the specified area.

Furthermore, the server 20 may detect a change in an environment by combining the first embodiment and the second embodiment. For example, the server 20 may detect a change in the environment based on the information from the image sensor 31 as in the first embodiment. The server 20A may detect a change in the environment based on the received power information for a range in which an image cannot be acquired by the image sensor 31.

According to at least one embodiment described above, it is possible to provide an information processing apparatus and a program capable of improving the estimation accuracy of a position of a moving object on a map.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an acquisition device configured to acquire distance sensor information, a moving distance of a plurality of wireless devices, and received power information from each of the wireless devices, and acquire image information from an image sensor;
a map generator configured to generate a map indicating an environment in which the wireless devices move based on the distance sensor information and the moving distance of each of the wireless devices acquired in a first period; and
an environment update unit configured to update the map in a case of detecting a change in the environment based on at least one of the distance sensor information, the received power information, and the image information acquired in a second period after the first period.

2. The information processing apparatus of claim 1, wherein
the received power information includes information regarding a strength of an interference signal different from a downlink signal of the information processing apparatus received by the wireless devices, and
in a case where a change in the strength of a first interference signal received by a first wireless device among the wireless devices is detected, the environment update unit is configured to update the map based on at least one of the distance sensor information, the received power information, and the image information of the first wireless device.

3. The information processing apparatus of claim 2, wherein,
when a second wireless device among the wireless devices and different from the first wireless device transmits an uplink signal to the information processing apparatus, the interference signal includes a signal received by the first wireless device.

4. The information processing apparatus of claim 2, wherein
the received power information further includes a time at which the wireless devices received the interference signal, a strength of the downlink signal, and a time at which the wireless devices have received the downlink signal, and
the information processing apparatus further comprises a memory configured to
store the strength of the interference signal in association with the time at which the interference signal has been received, and
store the strength of the downlink signal in association with the time at which the downlink signal has been received.

5. The information processing apparatus of claim 1, wherein
the acquisition device is further configured to acquire one or more pieces of the image information from each of one or more image sensors installed at positions different from a position of the image sensor, and
the environment update unit is configured to update the map in a case of detecting a change in the environment based on the one or more pieces of the image information.

6. The information processing apparatus of claim 1, wherein
the acquisition device is configured to acquire the image information at predetermined time intervals, and
the environment update unit is configured to
assign labels to pixels of a plurality of pieces of image information acquired at the predetermined time intervals,
obtain a time correlation of the pieces of image information assigned labels, and
update the map in a case where the time correlation is less than a threshold.

7. The information processing apparatus of claim 1, wherein
the environment update unit is configured to detect a change in the environment based on at least one of the distance sensor information and the received power information in a range in which the image information is not able to be acquired by the image sensor.

8. The information processing apparatus of claim 1, wherein
the first period includes a period in which the environment is in a steady state.

9. The information processing apparatus of claim 1, further comprising
a position estimator configured to estimate positions of the wireless devices on the map updated by the environment update unit based on the map updated by the environment update unit and at least one of the distance sensor information, the moving distance of the wireless devices, and the image information.

10. The information processing apparatus of claim 1, further comprising
a controller configured to transmit control signals for controlling movements of the wireless devices to the wireless devices.

11. The information processing apparatus of claim 10, wherein
the controller is configured to transmit a control signal for causing one or more of the wireless devices to move to a range in which the image information is unable to be acquired by the image sensor, and
the environment update unit is configured to update the map based on the distance sensor information and the received power information from the one or more wireless devices.

12. The information processing apparatus of claim 10, wherein,
in a case where a change in a strength of the control signal received by a third wireless device among the wireless devices and different from the first wireless device and the second wireless device is detected, the controller is configured to transmit a control signal for causing one or more fourth wireless devices among the wireless devices and different from the first wireless device, the second wireless device, and other than the third wireless device to move the one or more fourth wireless devices toward the third wireless device, and
the environment update unit is configured to update the map based on at least one of the distance sensor information of the third wireless device and the one or more fourth wireless devices, the received power information of the third wireless device and the one or more fourth wireless devices, and the image information.

13. The information processing apparatus of claim 1, wherein
the wireless devices are respectively mounted on a plurality of moving objects.

14. The information processing apparatus of claim 13, wherein
at least one of the moving objects comprises a conveyance robot.

15. The information processing apparatus of claim 13, wherein
the environment update unit is configured to update the map based on the distance sensor information, the moving distance of the wireless devices, and the received power information while the moving objects are moving.

16. An information processing apparatus comprising:
an acquisition device configured to acquire, from a plurality of wireless devices, a strength of an interference signal different from communication signals of the wireless devices; and
an environment update unit configured to update a map indicating an environment in a case where a change in the environment in which the wireless devices move is detected based on a temporal change in the strength of the interference signal.

17. A non-transitory computer readable storage medium having stored there on a computer program which is executable by one or more computers, the computer program configured to cause the one or more computers to execute functions of:
acquiring distance sensor information, a moving distance of a plurality of wireless devices, and received power information from each of the wireless devices, and acquiring image information from an image sensor;
generating a map indicating an environment in which the wireless devices move based on the distance sensor information and the moving distance of the wireless devices acquired in a first period; and
updating the map in a case of detecting a change in the environment based on at least one of the distance sensor information, the received power information, and the image information acquired in a second period after the first period.
